(19) United States
(12) Patent Application Publication
(10) Pub. No.: US 2020/0272772 A1
(43) Pub. Date: Aug. 27, 2020

(54) INDICATOR CALCULATION DEVICE, INDICATOR CALCULATION METHOD, AND NON-TRANSITORY RECORDING MEDIUM

(71) Applicant: NEC Corporation, Minato-ku, Tokyo (JP)

(72) Inventor: Takazumi KAWAI, Tokyo (JP)

(73) Assignee: NEC Corporation, Minato-ku, Tokyo (JP)

(21) Appl. No.: 16/761,587

(22) PCT Filed: Nov. 10, 2017
(86) PCT No.: PCT/JP2017/040628

§ 371 Date: May 5, 2020

(51) Int. Cl. G06F 30/20

(52) U.S. Cl. CPC G06F 30/20; G06F 2111/10

(57) ABSTRACT

Disclosed are an indicator calculation device and the like capable of calculating a preferable evaluation indicator even when a relevance among a plurality of evaluation indicators relating to a target system is unclear. An indicator calculation device executes a predetermined processing on a given range of a plurality of evaluation indicators for a target system and model information representing a relevance between the evaluation indicators and a parameter and, thereby, specifies ranges of the parameter in case that the plurality of the evaluation indicators are within the given range. The indicator calculation device executes a predetermined indicator calculation processing on the specified ranges of the parameter and target model information representing the model information regarding a target evaluation indicator for the target system and, thereby, calculates a characteristic value representing a character of the target evaluation indicator.

### TECHNICAL FIELD

The present invention relates to an indicator calculation device and the like that calculate an evaluation indicator for a target system.

### BACKGROUND ART

PTLs 1 to 3 each disclose a device that calculates a key performance indicator (KPI).

PTL 1 discloses a device that calculates an operation state in a plant when an evaluation indicator for the plant is optimum. The device acquires operation data representing an operation state in a plant and an evaluation indicator for the plant. The device generates a regression model representing a correlation between the acquired operation data and the acquired evaluation indicator, and calculates, based on the generated regression model, operation data in case that an evaluation indicator is optimum.

PTL 2 discloses a support device that calculates a control constant being able to control an operation of an automatic transmission for a vehicle. The support device calculates, for a range of a quantitative indicator for performance of the transmission, a control constant satisfying the range.

PTL 3 discloses a support device that determines a structure (or a shape) of an assembly constituted of a plurality of components. The support device calculates, based on a correlation between an objective variable representing a structure of the assembly and a design variable representing a value acquired with regard to the component, a value of the design variable in case that an objective variable is included in an allowable range. The support device calculates a value of the design variable by executing processing of repeatedly calculating an optimum value of the design variable.

### CITATION LIST

### Patent Literature

PTL 1: Japanese Unexamined Patent Application Publication No. 2012-074007

PTL 2: Japanese Unexamined Patent Application Publication No. 2008-261468

PTL 3: Japanese Unexamined Patent Application Publication No. 2003-141192

### SUMMARY OF INVENTION

### Technical Problem

A plurality of evaluation indicators for a target system may be mutually relevant (dependent). For example, there is a case where a first evaluation indicator for a target system is in a trade-off relation with a second evaluation indicator for the target system. There is a possibility that, as a result of adjusting a target system in such a way as to produce an optimum state with regard to the first evaluation indicator, a situation where a second evaluation indicator for the target system deteriorates arises. A cause of the arising of the situation is that, for example, a factor influencing the first evaluation indicator is common with a factor influencing the second evaluation indicator, but a state of the factor being optimum in relation of the first evaluation indicator is different from a state of the factor being optimum in relation of the second evaluation indicator. Therefore, it is difficult to adjust the target system in such a way that a plurality of evaluation indicators satisfy a predetermined criterion.

Even when the devices disclosed in PTLs 1 to 3 are used, it is difficult to calculate a preferable evaluation indicator when a relevance (dependency) among a plurality of evaluation indicators for a target system is unclear. A reason for this is that these devices adjust the target system while paying attention to only one evaluation indicator even though a plurality of evaluation indicators are mutually relevant (dependent).

Thus, one object of the present invention is to provide an indicator calculation device and the like being able to calculate a preferable evaluation indicator even when a relevance (dependency) among a plurality of evaluation indicators for a target system is unclear.

### Solution to Problem

As an aspect of the present invention, an indicator calculation device includes:

a range specification means for executing a predetermined processing on a given range of a plurality of evaluation indicators for a target system and model information representing a relevance between the evaluation indicators and a parameter and, thereby, specifying ranges of the parameter in case that the plurality of the evaluation indicators are within the given range; and

an indicator calculation means for executing a predetermined indicator calculation processing on the specified ranges of the parameter and target model information representing the model information regarding a target evaluation indicator for the target system and, thereby, calculating a characteristic value representing a character of the target evaluation indicator.

In addition, as another aspect of the present invention, an indicator calculation method includes:

executing a predetermined processing on a given range of a plurality of evaluation indicators for a target system and model information representing a relevance between the evaluation indicators and a parameter and, thereby, specifying ranges of the parameter in case that the plurality of the evaluation indicators are within the given range; and

executing a predetermined indicator calculation processing on the specified ranges of the parameter and target model information representing the model information regarding a target evaluation indicator for the target system and, thereby, calculating a characteristic value representing a character of the target evaluation indicator.

In addition, as another aspect of the present invention, an indicator calculation program causes a compute achieve:

a range specification function for executing a predetermined processing on a given range of a plurality of evaluation indicators for a target system and model information representing a relevance between the evaluation indicators and a parameter and, thereby, specifying ranges of the parameter in case that the plurality of the

evaluation indicators are within the given range; and an indicator calculation function for executing a predetermined indicator calculation processing on the specified ranges of the parameter and target model information representing the model information regarding a target evaluation indicator for the target system and, thereby, calculating a characteristic value representing a character of the target evaluation indicator.

Furthermore, the object is also achieved by a computer-readable recording medium that records the program.

### Advantageous Effects of Invention

An indicator calculation device and the like according to the present invention can calculate a preferable evaluation indicator even when a relevance (dependency) among a plurality of evaluation indicators for a target system is unclear.

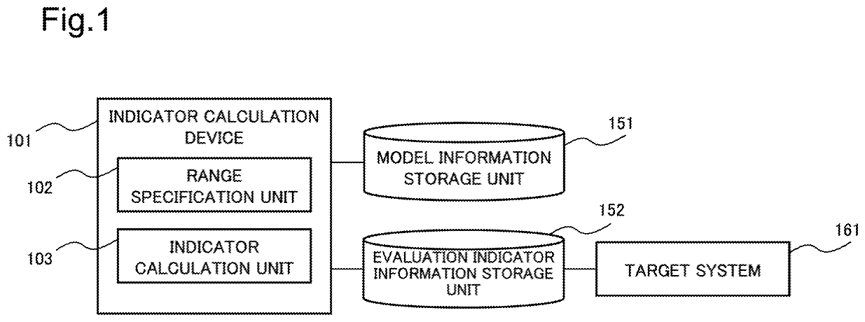

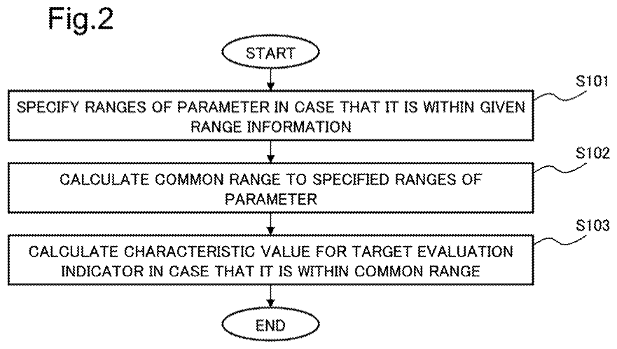

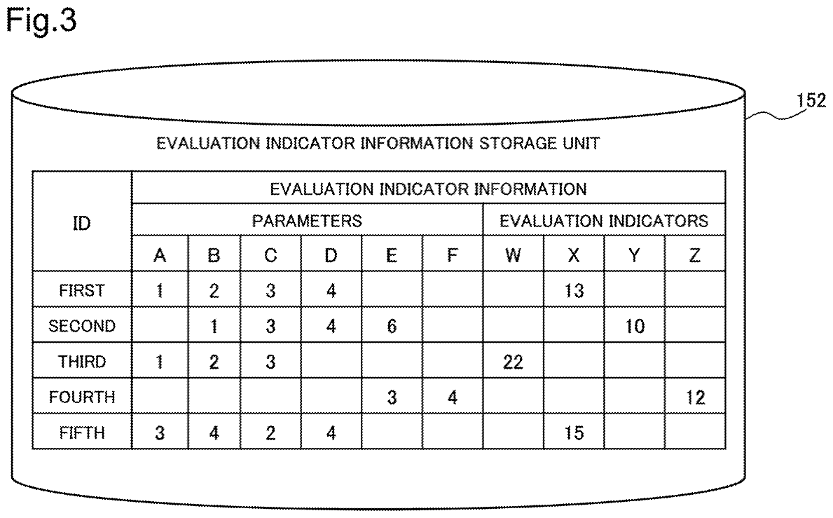

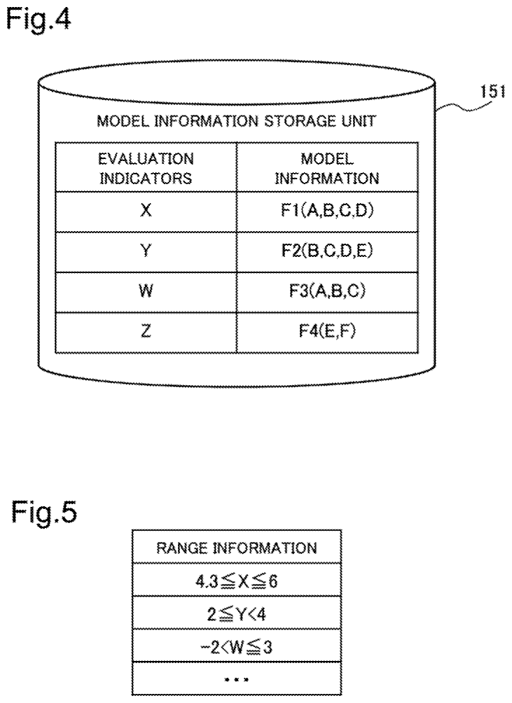

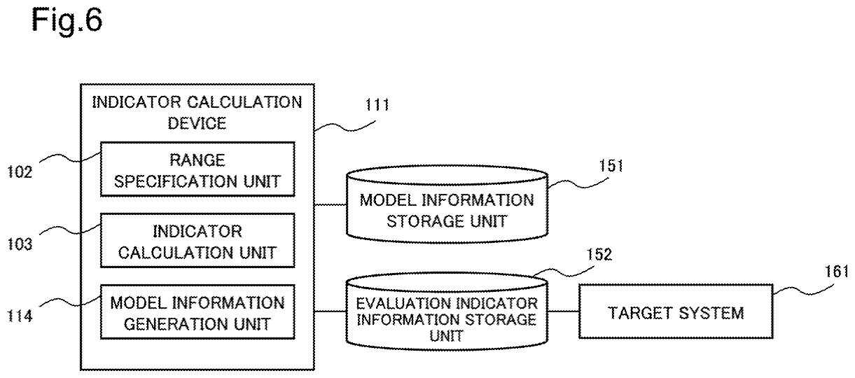

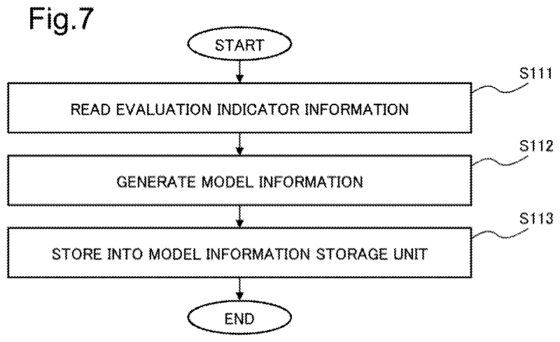

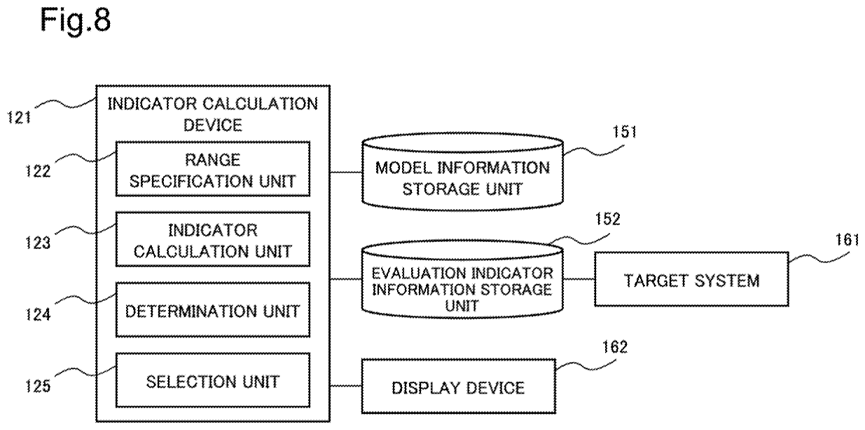

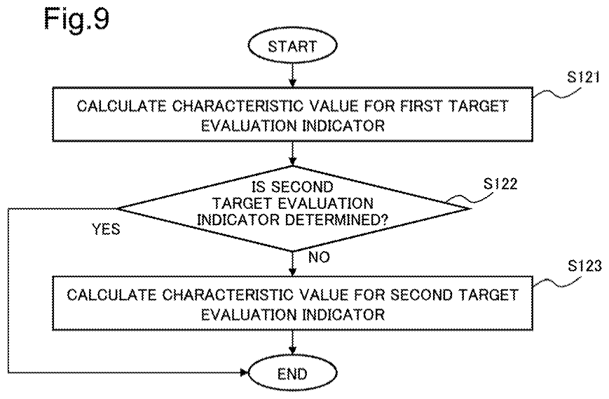

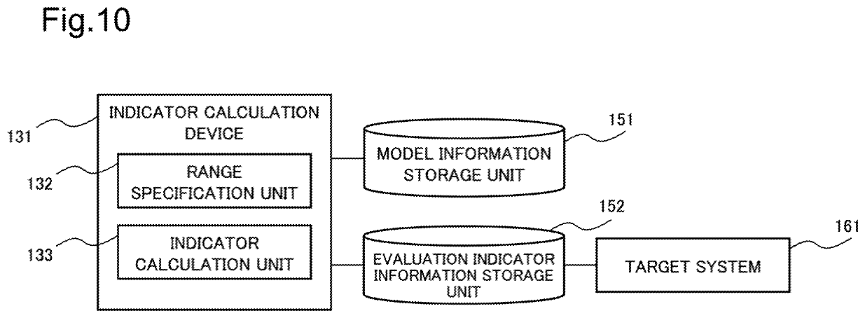

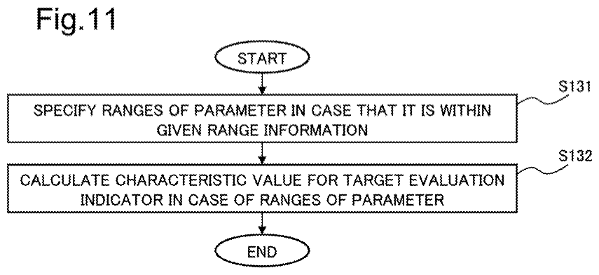

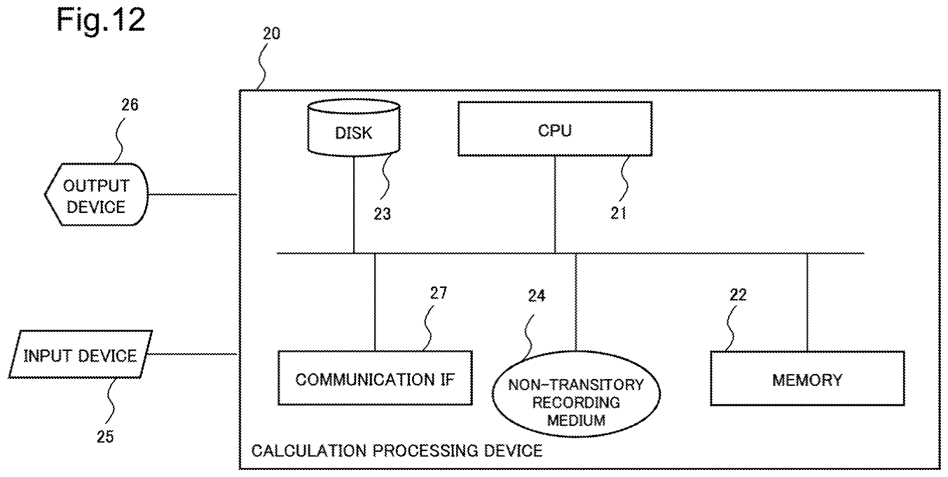

### BRIEF DESCRIPTION OF DRAWINGS

[FIG. 1] FIG. 1 is a block diagram illustrating a configuration of an indicator calculation device according to a first example embodiment of the present invention.

[FIG. 2] FIG. 2 is a flowchart illustrating flow of processing in the indicator calculation device according to the first example embodiment.

[FIG. 3] FIG. 3 is a diagram conceptually representing an evaluation indicator information storage unit storing evaluation indicator information.

[FIG. 4] FIG. 4 is a diagram conceptually representing a model information storage unit storing model information.

[FIG. 5] FIG. 5 is a diagram conceptually representing one example of range information.

[FIG. 6] FIG. 6 is a block diagram illustrating a configuration of an indicator calculation device according to a second example embodiment of the present invention.

[FIG. 7] FIG. 7 is a flowchart illustrating flow of processing in the indicator calculation device according to the second example embodiment.

[FIG. 8] FIG. 8 is a block diagram illustrating a configuration of an indicator calculation device according to a third example embodiment of the present invention.

[FIG. 9] FIG. 9 is a flowchart illustrating flow of processing in the indicator calculation device according to the third example embodiment.

[FIG. 10] FIG. 10 is a block diagram illustrating a configuration of an indicator calculation device according to a fourth example embodiment of the present invention.

[FIG. 11] FIG. 11 is a flowchart illustrating flow of processing in the indicator calculation device according to the fourth example embodiment.

[FIG. 12] FIG. 12 is a block diagram schematically illustrating a hardware configuration of a calculation processing device capable of achieving an indicator calculation device according to each of the example embodiments of the present invention.

### EXAMPLE EMBODIMENT

Next, example embodiments of the present invention will be described in detail with reference to the drawings.

### First Example Embodiment

A configuration included in an indicator calculation device 101 according to a first example embodiment of the present invention will be described in detail with reference to FIG. 1. FIG. 1 is a block diagram illustrating a configuration of the indicator calculation device 101 according to the first example embodiment of the present invention.

The indicator calculation device 101 according to the first example embodiment includes a range specification unit 102 and an indicator calculation unit 103.

The indicator calculation device 101 is connected or communicably connected to an evaluation indicator information storage unit 152 and a model information storage unit 151. The indicator calculation device 101 may include the evaluation indicator information storage unit 152 and the model information storage unit 151.

The evaluation indicator information storage unit 152 stores evaluation indicator information (described later with reference to FIG. 3) associating an evaluation indicator representing an indicator of evaluation regarding a target system 161 with a parameter acquired with regard to the target system 161. The evaluation indicator may be, for example, a KPI. The parameter is information quantitatively (or qualitatively) representing a factor influencing the evaluation indicator. A value of the evaluation indicator (hereinafter, represented as an “evaluation indicator value”) represents, for example, a degree of evaluation regarding the target system 161. The parameter represents, for example, a sensor measuring the target system 161, a type of an input to the target system 161, a type of a factor influencing the target system 161, or the like. A value of the parameter (hereinafter, represented as a “parameter value”) represents, for example, a value output by a sensor measuring the target system 161, a value representing quality of an input to the target system 161, or a degree (or state) of a factor regarding the target system 161.

A parameter, a factor, and an evaluation indicator are specifically described when the target system 161 is a thermal power generator (or a thermal power plant system). In this case, the evaluation indicator represents a power generation amount generated by the thermal power generator, or a degree of evaluation of power generation efficiency or the like regarding the target system 161. The factor (parameter) represents, for example, a degree of quality of fuel or the like such as oil, coal, or natural gas, or weather information such as weather, temperature, or humidity. Therefore, a parameter value is, for example, information quantitatively (or qualitatively) representing the degree of quality. When the target system 161 is a thermal power plant system, and an evaluation indicator is power generation efficiency, a value of a preferable evaluation indicator represents, for example, a maximum value of power generation efficiency.

The target system 161 may be a service provided to a customer. In this case, an evaluation indicator is, for example, a satisfaction degree of a customer, or the number of complaints from a customer. A factor (parameter) is, for example, information representing ease of use of the service. Therefore, a parameter value is, for example, information quantitatively (or qualitatively) representing ease of use.

The target system 161, a factor, a parameter, and an evaluation indicator are not limited to the examples described above.

The model information storage unit 151 stores model information (described later with reference to FIG. 4) representing a relevance between a parameter and an evaluation indicator. An evaluation indicator value calculated in response to the model information represents a degree of evaluation in case that a parameter is a certain value. The evaluation indicator value is calculated by, for example, the indicator calculation unit 103. The model information represents, for example, a regression equation acquired by performing a regression analysis of a relevance between a parameter value and an evaluation indicator value, or a coefficient constituting the regression equation. The model information can be represented by, for example, a differentiable function such as a polynomial equation, a Gaussian radial basis function (hereinafter, a radial basis function represented as an “RBF”), a multiquadric RBF, an inverse quadratic RBF, or a polyharmonic spline RBF. The model information may not be a differentiable function. Model information is not limited to the examples described above.

The inventor of the present application has found out that, for example, by representing, by use of a Gaussian RBF, a relevance between power generation efficiency regarding a thermal power generator (or a thermal power plant system) and quality of coal being fuel when power is generated with the thermal power generator (or fuel utilized by the thermal power plant system), the power generation efficiency can be accurately predicted. Moreover, the inventor of the present application has found out that a relevance between the power generation efficiency and a parameter (or an environment value such as atmospheric temperature or atmospheric pressure) being able to control the thermal power generator can be accurately represented by use of a Gaussian RBF. A relevance is not limited to the examples described above.

The evaluation indicator information storage unit 152 will be described with reference to FIG. 3. FIG. 3 is a diagram conceptually representing the evaluation indicator information storage unit 152 storing evaluation indicator information.

Evaluation indicator information is information associating one or more parameters with an evaluation indicator in case that the parameter is a certain value. The evaluation indicator information storage unit 152 may store evaluation indicator information regarding a plurality of evaluation indicators. In evaluation indicator information, a parameter associated with an evaluation indicator may differ from one evaluation indicator to another. In FIG. 3, for convenience of description, each of pieces of evaluation indicator information is given an identifier (hereinafter, represented as an “ID”) that uniquely identifies the evaluation indicator information. However, the identifier may not be necessarily given to evaluation indicator information.

Referring to FIG. 3, in a piece of first evaluation indicator information being a piece of evaluation indicator information of which an ID is “first”, a parameter A “1”, a parameter B “2”, a parameter C “3”, a parameter D “4”, and an evaluation indicator X “13” are associated with one another. This represents that a value of the evaluation indicator X is “13” when a value of the parameter A is “1”, a value of the parameter B is “2”, a value of the parameter C is “3”, and a value of the parameter D is “4”. In a piece of the first evaluation indicator information, the evaluation indicator X is not associated with a parameter E and a parameter F. This represents that the evaluation indicator X is not dependent on (i.e., does not have a relevance with) a value of the parameter E and a value of the parameter F.

In a piece of second evaluation indicator information being a piece of evaluation indicator information of which an ID is “second”, a parameter B “1”, a parameter C “3”, a parameter D “4”, a parameter E “6”, and an evaluation indicator Y “10” are associated. This represents that a value of the evaluation indicator Y is “10” when a value of the parameter B is “1”, a value of the parameter C is “3”, a value of the parameter D is “4”, and a value of the parameter E is “6”.

Herein, a situation where a plurality of evaluation indicators are mutually dependent will be described with reference to FIG. 3. In this description, for convenience of description, it is assumed that one value of a parameter in case that a certain evaluation indicator is a characteristic value (e.g., a maximum value, a minimum value, a local maximum value, a local minimum value, or the like) is always determined. It is assumed that evaluation of the target system 161 is higher as the certain evaluation indicator is a greater value. It is assumed that evaluation of the target system 161 is lower as the certain evaluation indicator is a smaller value. For convenience of description, in the following description, it is assumed that the characteristic value is a maximum value. However, a characteristic value is not limited to a maximum value.

In the first evaluation indicator information, the evaluation indicator X is associated with the parameters A to D. Therefore, the value of the parameter A, the value of the parameter B, the value of the parameter C, and the value of the parameter D in case that the evaluation indicator X is maximum are each determined at one value by the assumption described above. In the second evaluation indicator information, the evaluation indicator Y is associated with the parameters B to E. Therefore, the evaluation indicator X and the evaluation indicator Y are both dependent on the parameter B, the parameter C, and the parameter D. In other words, the evaluation indicator X and the evaluation indicator Y are mutually relevant.

According to the assumption described above, the value of the parameter B, the value of the parameter C, and the value of the parameter D are determined at one value when the evaluation indicator X is maximum. As a result, a maximum value of the evaluation indicator Y in case that the evaluation indicator X is maximum is calculated by changing the parameter E that is not dependent on the evaluation indicator X. The processing is executed by, for example, the indicator calculation unit 103. In this case, the evaluation indicator X and the evaluation indicator Y are both influenced by the parameters B to D, and therefore, are mutually dependent. In other words, the evaluation indicator X and the evaluation indicator Y are relevant.

In a piece of third evaluation indicator information being a piece of evaluation indicator information of which an ID is “third”, an evaluation indicator Z is associated with the parameters A to C. Therefore, the evaluation indicator X and the evaluation indicator Z are both influenced by the parameter A, the parameter B, and the parameter C, and therefore, are mutually dependent. Since the values of the parameters A to C are determined at one value by the assumption described above when the evaluation indicator X is maximum, a value of an evaluation indicator W is determined by the determined one value. Therefore, when the evaluation indicator X is maximum, a value of the evaluation indicator W is determined at one value.

In a piece of fourth evaluation indicator information being a piece of evaluation indicator information of which an ID is “fourth”, an evaluation indicator Z is associated with the parameters E and F. Therefore, a parameter influencing both the evaluation indicator X and the evaluation indicator Z does not exist. In other words, the evaluation indicator Z is independent of the evaluation indicator X. Specifically, the evaluation indicator Z and the evaluation indicator X do not have a relevance (dependency).

The model information storage unit 151 will be described with reference to FIG. 4. FIG. 4 is a diagram conceptually representing the model information storage unit 151 storing model information.

The model information storage unit 151 can store model information regarding an evaluation indicator. The model information is information representing a relevance between a parameter (factor) and an evaluation indicator. In the model information exemplified in FIG. 4, an evaluation indicator “X” is associated with a piece of model information “F1(A, B, C, D)”. This represents that the evaluation indicator “X” can be calculated by executing processing “F1” with respect to the parameters A to D. When F1 is represented by use of a numerical expression, the processing F1 represents processing of calculating an evaluation indicator in accordance with the numerical expression.

Model information may be given information, or may be information calculated based on evaluation indicator information (exemplified in FIG. 3). For example, model information is generated by executing predetermined generation processing (e.g., a regression analysis, a least squares method, or the like) on evaluation indicator information associating a value of each parameter with an evaluation indicator. The predetermined generation processing may be processing of calculating a relevance between a parameter and an evaluation indicator, and may be, for example, processing such as data mining. Predetermined generation processing is not limited to the examples described above.

Model information can also be conceptually represented by use of a function as indicated in Equation 1 below. For convenience of description, it is assumed that there are m (note, however, that m is a natural number) kinds of parameters regarding the target system 161. It is assumed that the m kinds of parameters are represented as X1 to Xm. In this case, model information representing a relevance between, for example, an I-th (note, however, that I is a natural number) evaluation indicator and each parameter can be conceptually represented by use of, for example, a function FI, as indicated in Equation 1.

(I-th evaluation indicator)=FI(X1, X2, . . . , Xm) (Equation 1).

Although it is assumed, for convenience of description, that the function FI includes all the parameters X1 to Xm, the function FI may include only some of the parameters. Alternatively, even when the function FI includes all the parameters X1 to Xm, an I-th evaluation indicator can be represented in such a way as to be formally exemplified in Equation 1, by setting, to 0, a coefficient regarding a parameter that does not influence the I-th evaluation indicator. The same also applies to example embodiments presented below.

Next, processing in the indicator calculation device 101 according to the first example embodiment of the present invention will be described in detail with reference to FIG. 2. FIG. 2 is a flowchart illustrating flow of the processing in the indicator calculation device 101 according to the first example embodiment.

In the indicator calculation device 101, the range specification unit 102 receives, with regard to each evaluation indicator, given range information representing a range of the evaluation indicator, for example, from outside. The given range information is information representing a range of values permissible by an evaluation indicator for the target system 161, for example, as illustrated in FIG. 5. FIG. 5 is a diagram conceptually representing one example of range information. The range information is information including a range of values regarding one or more evaluation indicators.

The range information exemplified in FIG. 5 includes a piece of range information regarding the evaluation indicator X, a piece of range information regarding the evaluation indicator Y, and a piece of range information regarding the evaluation indicator W. The range information regarding the evaluation indicator X is information representing a range of values of the evaluation indicator X, and is “4.3≤X≤6” in the range information exemplified in FIG. 5. The range information is information representing a range that a value of the evaluation indicator X is equal to or more than 4.3, and equal to or less than 6. The range information regarding the evaluation indicator Y is information representing a range of values of the evaluation indicator Y, and is “2≤Y≤4” in the range information exemplified in FIG. 5. The range information is information representing a range that a value of the evaluation indicator Y is equal to or more than 2, and less than 4. The range information regarding the evaluation indicator W is information representing a range of values of the evaluation indicator W, and is “−2<W≤3” in the range information exemplified in FIG. 5. The range information is information representing a range that a value of the evaluation indicator W is more than −2, and equal or less than 3. Range information is not limited to the examples described above.

When a plurality of evaluation indicators are represented as an I-th evaluation indicator (exemplified in Equation 1), range information regarding the I-th evaluation indicator can also be represented as, for example, “LI≤I-th evaluation indicator≤HI” (note, however, that LI and HI each represent a real number). However, in given range information, LI represents a minimum value of an I-th evaluation indicator (exemplified in Equation 1). HI represents a maximum value of an I-th evaluation indicator (exemplified in Equation 1). The given range information is information including a piece of range information regarding each evaluation indicator. The given range information may include range information regarding a target evaluation indicator, or may not include range information regarding the target evaluation indicator.

The range specification unit 102 reads, from the model information storage unit 151, a piece of model information (exemplified in FIG. 4) regarding one evaluation indicator included in given range information. The range specification unit 102 executes predetermined parameter calculation processing on a piece of the read model information and range information regarding the one evaluation indicator, and thereby, specifies a range of the parameter value in case that the one evaluation indicator is included in a range represented by the range information (step S101).

In step S101, the range specification unit 102 reads, from the model information storage unit 151 (exemplified in FIG. 4), a piece of model information “FI(X1, X2, . . . , Xm)” regarding an I-th evaluation indicator included in given range information. The range specification unit 102 executes predetermined parameter calculation processing on a piece of the read model information “FI(X1, X2, . . . , Xm)” and the range information “LI≤I-th evaluation indicator≤HI” regarding the I-th evaluation indicator, and thereby, specifies ranges of the parameters X1 to Xm in case that “LI≤I-th evaluation indicator≤HI” is satisfied. The range specification unit 102 does not necessarily need to specify ranges with regard to all of the parameters X1 to Xm, and may specify ranges with regard to some of the parameters. The range specification unit 102 executes processing illustrated in step S101 with regard to each evaluation indicator included in range information.

The predetermined parameter calculation processing is processing of specifying a parameter value in case that an evaluation indicator is a certain value (e.g., a characteristic value), and is, for example, processing such as a bisection method or a Newton method. In the predetermined parameter calculation processing, for example, processing as described above is executed on each value included in range information regarding a certain evaluation indicator, and a range including a specified parameter value is specified. Alternatively, the predetermined parameter calculation processing may be processing of setting a parameter to a random number (or a pseudo-random number), calculating the evaluation indicator value by applying model information regarding the evaluation indicator to the set random number, and outputting the parameter value in case that the calculated evaluation indicator value is included in a range represented by the given range information. Predetermined parameter calculation processing is not limited to the examples described above.

The range specification unit 102 calculates a range (hereinafter, represented as a “common range”) common to a range of a parameter calculated with regard to each evaluation indicator (step S102). Specifically, the range specification unit 102 specifies a range of a parameter in case that all of a plurality of evaluation indicators are included in a range represented by given range information. In other words, all evaluation indicator values calculated by applying model information regarding each evaluation indicator to a parameter value included in a common range specified by the range specification unit 102 are values within a range represented by given range information.

For example, when a range of the parameter B calculated with regard to the evaluation indicator X is equal to or more than 3 and equal to or less than 6, and a range of the parameter B calculated with regard to the evaluation indicator Y is equal to or more than 4 and equal to or less than 8, the range specification unit 102 calculates, as the common range, a range of the parameter B being equal to or more than 4 and equal to or less than 6.

When there is no common range, the range specification unit 102 may output information representing that there is no common range.

Next, the indicator calculation unit 103 executes predetermined indicator calculation processing on the common range specified by the range specification unit 102 and a piece of model information (hereinafter, represented as “target model information”) regarding a target evaluation indicator, and thereby, calculates a characteristic value regarding the target evaluation indicator (step S103). The characteristic value is, for example, a maximum value, a minimum value, a local maximum value, or a local minimum value. The indicator calculation unit 103 may further calculate a range of the target evaluation indicator, or calculate the range instead of a characteristic value. A value calculated by the indicator calculation unit 103 is not limited to the examples described above.

The predetermined indicator calculation processing is, for example, processing of calculating a maximum value of the target evaluation indicator in case that a parameter value is within the common range. The predetermined indicator calculation processing is achieved by, for example, processing indicated in steps C1 to C4 below.

(Step C1) In a common range, an inclination (or a difference, a differential, or the like) of target model information regarding a target evaluation indicator is calculated,

(Step C2) a parameter value in case that a calculated value is 0 is calculated,

(Step C3) a value of the target evaluation indicator is calculated by applying the target model information to the calculated parameter value; i.e., a local maximum value (or a local minimum value) of the value of the target evaluation indicator is calculated, and

(Step C4) the target model information is applied to a parameter value included in a boundary of the common range, and a maximum value is selected among the calculated value and the local maximum value (or local minimum value).

The predetermined indicator calculation processing is achieved by, for example, processing indicated in steps D1 to D3 below.

(Step D1) A parameter value included in a common range specified by the range specification unit 102 is randomly selected,

(Step D2) a value of a target evaluation indicator is calculated by applying target model information regarding the target evaluation indicator to the selected parameter value, and

(Step D3) a maximum value is selected from the calculated target evaluation indicators.

The predetermined indicator calculation processing is not limited to the examples described above. Even when a characteristic value is, for example, a minimum value, a local maximum value, or a local minimum value, the predetermined indicator calculation processing can be achieved by processing similar to the processing described above.

The indicator calculation unit 103 may output at least one of a characteristic value calculated with regard to a target evaluation indicator and a range of the target evaluation indicator. The indicator calculation unit 103 may calculate a parameter value for calculating a characteristic value calculated with regard to the target evaluation indicator and output the calculated parameter value.

As a result of the processing illustrated in step S103, when a condition regarding a range of each evaluation indicator within given range information is satisfied, the indicator calculation unit 103 calculates a characteristic value (maximum, minimum, local maximum, local minimum, or the like) regarding the target evaluation indicator.

Although the processing in the indicator calculation device 101 has been described with reference to the example in which, for convenience of description, the indicator calculation unit 103 calculates a maximum value (or a minimum value) as a characteristic value, the characteristic value may not be a mathematically defined maximum value (or minimum value). For example, a characteristic value may be an approximate value of a maximum value, or an approximate value of a minimum value. Specifically, a characteristic value may be information representing a character of an evaluation indicator, and is not limited to the examples described above.

Next, an advantageous effect regarding the indicator calculation device 101 according to the first example embodiment of the present invention will be described.

The indicator calculation device 101 according to the first example embodiment can calculate a preferable evaluation indicator even when a relevance (dependency) among a plurality of evaluation indicators for the target system 161 is unclear. A reason for this is that the indicator calculation device 101 specifies a state of the target system 161 in case that a plurality of evaluation indicators are within a range represented by given range information, and generates information regarding a case where a target evaluation indicator is a characteristic value among the specified states.

For example, a designer who designs an evaluation indicator for the target system 161 can easily specify an evaluation indicator by referring to a characteristic value of an evaluation indicator generated by the indicator calculation device 101, without analyzing a state in the target system 161, and a relevance among a plurality of evaluation indicators.

### Second Example Embodiment

A second example embodiment of the present invention based on the first example embodiment described above will be described.

In the following description, a characteristic part according to the present example embodiment will be mainly described, and overlapped description will be omitted for a component similar to that in the first example embodiment described above by giving the same reference sign thereto.

A configuration included in an indicator calculation device 111 according to the second example embodiment of the present invention will be described in detail with reference to FIG. 6. FIG. 6 is a block diagram illustrating a configuration of the indicator calculation device 111 according to the second example embodiment of the present invention.

The indicator calculation device 111 according to the second example embodiment includes a range specification unit 102, an indicator calculation unit 103, and a model information generation unit 114.

The indicator calculation device 111 is connected or communicably connected to an evaluation indicator information storage unit 152 and a model information storage unit 151. The indicator calculation device 111 may include the evaluation indicator information storage unit 152 and the model information storage unit 151.

The range specification unit 102 and the indicator calculation unit 103 execute processing similar to processing described above with reference to FIG. 2. The model information generation unit 114 generates, based on evaluation indicator information (exemplified in FIG. 3) stored in the evaluation indicator information storage unit 152, model information representing a relevance between a parameter and an evaluation indicator, in response to predetermined generation processing.

Next, processing in the indicator calculation device 111 according to the second example embodiment of the present invention will be described in detail with reference to FIG. 7. FIG. 7 is a flowchart illustrating flow of processing in the indicator calculation device 111 according to the second example embodiment.

The model information generation unit 114 reads a piece of evaluation indicator information (exemplified in FIG. 3) stored in the evaluation indicator information storage unit 152 (step S111). The model information generation unit 114 executes predetermined generation processing on each evaluation indicator included in a piece of the read evaluation indicator information (exemplified in FIG. 3), and thereby, generates model information representing a relevance between the evaluation indicator and a value of a parameter (step S112). The model information generation unit 114 generates information associating model information generated with regard to an evaluation indicator with the evaluation indicator, and stores the generated information in the model information storage unit 151 (exemplified in FIG. 4) (step S113).

The predetermined generation processing will be more specifically described. The model information generation unit 114 selects, from evaluation indicator information (exemplified in FIG. 3), a piece of evaluation indicator information regarding a certain evaluation indicator. For example, when generating model information regarding an evaluation indicator X, the model information generation unit 114 selects, from evaluation indicator information (exemplified in FIG. 3), a piece of evaluation indicator information (in this case, first evaluation indicator information and fifth evaluation indicator information) regarding the evaluation indicator X. The model information generation unit 114 generates model information by calculating a regression equation fitted to a piece of the selected evaluation indicator information. A method of calculating a regression equation is, for example, a least squares method or the like. With regard to an evaluation indicator different from the evaluation indicator X as well, the model information generation unit 114 generates model information regarding each evaluation indicator by executing processing similar to processing executed with regard to the evaluation indicator X.

The model information generation unit 114 may generate model information, for example, in response to updating of evaluation indicator information. Alternatively, the model information generation unit 114 may generate model information in response to processing of receiving given range information. In this case, the range specification unit 102 specifies, by use of model information generated by the model information generation unit 114, a range of a parameter in case that an evaluation indicator is within a range represented by given range information.

When model information is represented by use of a basis function, one basis function is allocated to each factor in a target system 161, for example. Model information can be represented by use of, for example, a linear sum of a plurality of basis functions. In this case, a basis function having a greater value of a coefficient has a greater influence on an evaluation indicator. A basis function having a smaller value of a coefficient has a smaller influence on the evaluation indicator.

When model information is represented by use of a linear sum of basis functions, the model information generation unit 114 may specify a basis function having the greatest value of a coefficient in the linear sum out of the generated model information, and output information representing a factor (or a parameter) related to the specified basis function. In other words, the model information generation unit 114 may specify, based on the generated model information, a factor (or a parameter) having the greatest influence on the evaluation indicator, and output information representing the specified factor.

Alternatively, the model information generation unit 114 may specify a parameter having a value of a coefficient satisfying a predetermined criterion in the model information generated with regard to a certain evaluation indicator, and output information representing the specified parameter. In other words, the model information generation unit 114 may specify a parameter in which a relevance between a certain evaluation indicator and the parameter satisfies a predetermined criterion, and output information representing the specified parameter. The predetermined criterion is, for example, a condition that a value of the coefficient is equal to or more than a certain threshold value. By executing such processing, the model information generation unit 114 can specify a parameter having a great influence on an evaluation indicator. The evaluation indicator may be a target evaluation indicator.

Alternatively, the model information generation unit 114 may output information representing a factor (or a parameter) related to the basis function in descending order of the coefficients. In other words, the model information generation unit 114 outputs, based on the generated model information, information representing a factor (or a parameter) in descending order of influences on the evaluation indicator.

Next, an advantageous effect regarding the indicator calculation device 111 according to the second example embodiment of the present invention will be described.

The indicator calculation device 111 according to the second example embodiment can calculate a preferable evaluation indicator even when a relevance (dependency) among a plurality of evaluation indicators for the target system 161 is unclear. A reason for this is similar to a reason described in the first example embodiment.

Furthermore, the indicator calculation device 111 according to the second example embodiment can more accurately generate information regarding a target evaluation indicator. A reason for this is that model information is generated based on evaluation indicator information stored in the evaluation indicator information storage unit 152. The model information generated by the model information generation unit 114 is the latest model information regarding the evaluation indicator information (exemplified in FIG. 3). The indicator calculation device 111 generates, based on the latest model information, information regarding the target evaluation indicator. Therefore, the indicator calculation device 111 can more accurately generate information regarding a target evaluation indicator.

The indicator calculation device 111 provides information regarding a value of a coefficient in model information, and thereby, enables a user to know a factor (or a parameter) having a great influence on an evaluation indicator. Further, the indicator calculation device 111 provides information representing a factor in descending order of influences on an evaluation indicator, and thereby, enables a user to know magnitude of an influence a factor (or a parameter) has on an evaluation indicator.

### Third Example Embodiment

Next, a third example embodiment of the present invention based on the first example embodiment described above will be described.

In the following description, a characteristic part according to the present example embodiment will be mainly described, and overlapped description will be omitted for a component similar to that in the first example embodiment described above by giving the same reference sign thereto.

A configuration included in an indicator calculation device 121 according to the third example embodiment of the present invention will be described in detail with reference to FIG. 8. FIG. 8 is a block diagram illustrating a configuration of the indicator calculation device 121 according to the third example embodiment of the present invention.

The indicator calculation device 121 according to the third example embodiment includes a range specification unit 122, an indicator calculation unit 123, a determination unit 124, and a selection unit 125.

The indicator calculation device 121 is connected or communicably connected to an evaluation indicator information storage unit 152 and a model information storage unit 151. The indicator calculation device 121 may include the evaluation indicator information storage unit 152 and the model information storage unit 151. The indicator calculation device 121 is connected to a display device 162.

The indicator calculation device 121 generates, based on given range information, information regarding a plurality of evaluation indicators. For example, the indicator calculation device 121 determines a characteristic value (maximum, minimum, local minimum, local maximum, or the like) regarding a plurality of target evaluation indicators, or determines a characteristic value regarding some of a plurality of the target evaluation indicators, and thereby, generates information representing whether a value of another target evaluation indicator is determined.

Hereinafter, for convenience of description, it is assumed that there are two target evaluation indicators. It is assumed that the two target evaluation indicators are represented as a “first target evaluation indicator” and a “second target evaluation indicator”. It is also assumed that the first target evaluation indicator is an evaluation indicator X in evaluation indicator information exemplified in FIG. 3, and a characteristic value regarding the evaluation indicator X (i.e., the first target evaluation indicator) is calculated in response to processing described above with reference to FIG. 2.

Next, processing in the indicator calculation device 121 according to the third example embodiment of the present invention will be described in detail with reference to FIG. 9. FIG. 9 is a flowchart illustrating flow of processing in the indicator calculation device 121 according to the third example embodiment.

With regard to the first target evaluation indicator, the indicator calculation unit 123 calculates a characteristic value (maximum, minimum, local maximum, local minimum, or the like) regarding the first target evaluation indicator (the evaluation indicator X in the example described above) by executing processing similar to processing described above with reference to FIG. 2 (step S121).

For convenience of description, it is assumed that the indicator calculation unit 123 has calculated a characteristic value regarding the evaluation indicator X, and a parameter value in case that the evaluation indicator X is the characteristic value. In evaluation indicator information exemplified in FIG. 3, the indicator calculation unit 123 calculates a value of a parameter A, a value of a parameter B, a value of a parameter C, and a value of a parameter D in case that the evaluation indicator X is the characteristic value. It is also assumed that each of the calculated values of the plurality of parameters (in this example, the parameters A to D) is one value.

The determination unit 124 determines whether the second target evaluation indicator is determined by the parameter value calculated by the indicator calculation unit 123 (step S122). The determination unit 124 specifies a parameter set including a parameter associated with the first target evaluation indicator, for example, in the evaluation indicator information (exemplified in FIG. 3) stored in the evaluation indicator information storage unit 152. One or more parameters may be included in the parameter set. When the first target evaluation indicator is the evaluation indicator X, the determination unit 124 specifies that, based on the evaluation indicator information (exemplified in FIG. 3) or model information (exemplified in FIG. 4), the evaluation indicator X is associated with the parameters A to D. In other words, the determination unit 124 specifies the parameters A to D as a parameter set regarding the evaluation indicator X.

With regard to the second target evaluation indicator as well, the determination unit 124 specifies a parameter associated with the second target evaluation indicator, in the evaluation indicator information (exemplified in FIG. 3) or the model information (exemplified in FIG. 4). For example, when the second target evaluation indicator is an evaluation indicator Y, the determination unit 124 specifies, based on the evaluation indicator information, the evaluation indicator Y is associated with the parameters B to E. In this case, the determination unit 124 specifies the parameters B to E as a parameter set regarding the evaluation indicator Y.

Next, the determination unit 124 determines whether the parameter set (hereinafter, represented as a “first parameter set”) specified with regard to the first evaluation indicator information includes each parameter in the parameter set (hereinafter, represented as a “second parameter set”) specified with regard to the second target evaluation indicator.

When the first parameter set includes each parameter in the second parameter set, the second target evaluation indicator is determined by a value of a parameter determined when the first target evaluation indicator is a characteristic value. In this case, the determination unit 124 determines that the second target evaluation indicator is determined by a value of a parameter generated by the indicator calculation unit 123 (YES in step S122). In the example illustrated in FIG. 3, a parameter set (i.e., the parameters A to D) regarding the evaluation indicator X includes a parameter set (i.e., the parameters A to C) regarding an evaluation indicator W. Therefore, a value of the evaluation indicator W is determined by a parameter set in case that the evaluation indicator X is a characteristic value.

When there is a parameter that is not included in the first parameter set among the parameters in the second parameter set, the second target evaluation indicator is not determined even when the first target evaluation indicator is a characteristic value. For example, referring to FIG. 3, the parameter set regarding the evaluation indicator Y includes the parameter E that is not included in the parameter set regarding the evaluation indicator X. Similarly, a parameter set regarding the evaluation indicator Z includes the parameter E and a parameter F that are not included in the parameter set regarding the evaluation indicator X. Therefore, in these cases, the evaluation indicator Y and the evaluation indicator Z are not determined by a parameter set in case that the evaluation indicator X is a characteristic value. In this case, the determination unit 124 determines that the second target evaluation indicator is not determined by a value of a parameter generated by the indicator calculation unit 123 (NO in step S122).

In contrast to the assumption described above, the second target evaluation indicator is not determined even when the first target evaluation indicator is a characteristic value, when the first target evaluation indicator is a characteristic value but a parameter for calculating the characteristic value can take a plurality of values. When the parameter can take a plurality of values, the determination unit 124 determines that the second target evaluation indicator is not determined by a value of a parameter generated by the indicator calculation unit 123 (NO in step S122).

Next, when a value of the second target evaluation indicator is not determined even when a value of the first target evaluation indicator is determined (NO in step S122), the indicator calculation unit 123 calculates a characteristic value regarding the second target evaluation indicator (step S123). In step S123, the indicator calculation unit 123 calculates a characteristic value regarding the second target evaluation indicator with a parameter value in case that the first target evaluation indicator is a characteristic value, in a common range specified by the range specification unit 122 in step S102. For convenience of description, a parameter value in case that the first target evaluation indicator is a characteristic value in the common range is represented as a “second common range”. The indicator calculation unit 123 executes predetermined indicator calculation processing with regard to model information regarding the second target evaluation indicator, and the second common range, and thereby, calculates a characteristic value regarding the second target evaluation indicator information. The indicator calculation unit 123 may calculate a range of the second target evaluation indicator.

The predetermined indicator calculation processing is, for example, processing of calculating a value of the second target evaluation indicator in case that an inclination of a regression equation regarding the second target evaluation indicator is 0, and a value of the second target evaluation indicator in a value of each parameter on a boundary of the second common range, and specifying a maximum value among calculated values. Alternatively, the predetermined indicator calculation processing may be processing of calculating a value by applying, to a value of a parameter included in the second common range, processing indicated by a regression equation regarding the second target evaluation indicator, and calculating a maximum value of the calculated value. The predetermined indicator calculation processing is not limited to the examples described above.

When the second target evaluation indicator is determined (YES in step S122), the selection unit 125 may select an evaluation indicator of which a value is not determined even when the first target evaluation indicator is a characteristic value among a plurality of evaluation indicators. In this case, the range specification unit 122 calculates a characteristic value regarding the evaluation indicator selected by the selection unit 125.

Alternatively, when the second target evaluation indicator is determined (YES in step S122), the determination unit 124 may display, on the display device 162, information representing that a value of the second target evaluation indicator is determined. In this case, the selection unit 125 may further calculate a value of the second target evaluation indicator, and display, on the display device 162, information representing the calculated value of the second target evaluation indicator.

Next, an advantageous effect regarding the indicator calculation device 121 according to the third example embodiment of the present invention will be described.

The indicator calculation device 121 according to the third example embodiment can calculate a preferable evaluation indicator even when a relevance (dependency) among a plurality of evaluation indicators for the target system 161 is unclear. A reason for this is similar to a reason described in the first example embodiment.

Furthermore, the indicator calculation device 121 according to the third example embodiment can generate characteristic values regarding a plurality of target evaluation indicators in a small amount of processing. A reason for this is that an amount of processing is smaller when a characteristic value regarding each target evaluation indicator is sequentially calculated than when characteristic values regarding a plurality of target evaluation indicators are calculated in one processing. Since the indicator calculation device 121 determines the first target evaluation indicator being regarded as the most important, and then determines the second target evaluation indicator being the next most important, the indicator calculation device 121 can determine the second target evaluation indicator being the next most important in a small amount of processing, while maintaining the first target evaluation indicator.

### Fourth Example Embodiment

Next, a fourth example embodiment of the present invention will be described.

In the following description, a characteristic part according to the present example embodiment will be mainly described, and overlapped description will be omitted for a component similar to that in each of the example embodiments described above by giving the same reference sign thereto.

A configuration included in an indicator calculation device 131 according to the fourth example embodiment of the present invention will be described in detail with reference to FIG. 10. FIG. 10 is a block diagram illustrating a configuration of the indicator calculation device 131 according to the fourth example embodiment of the present invention.

The indicator calculation device 131 according to the fourth example embodiment includes a range specification unit 132 and an indicator calculation unit 133.

The indicator calculation device 131 is connected or communicably connected to an evaluation indicator information storage unit 152 and a model information storage unit 151. The indicator calculation device 131 may include the evaluation indicator information storage unit 152 and the model information storage unit 151.

Next, processing in the indicator calculation device 131 according to the fourth example embodiment of the present invention will be described in detail with reference to FIG. 11. FIG. 11 is a flowchart illustrating flow of processing in the indicator calculation device 131 according to the fourth example embodiment.

The range specification unit 132 receives given range information for a plurality of evaluation indicators for the target system 161. The range specification unit 132 specifies, based on the model information storage unit 151, model information (exemplified in FIG. 4) regarding an evaluation indicator included in the received given range information. The model information is model information similar to model information described with reference to FIG. 4. The given range information is information representing a range regarding an evaluation indicator. The model information is, for example, model information “F3(A, B, C)” regarding an evaluation indicator W, as exemplified in FIG. 4. The given range is, for example, information representing ranges regarding an evaluation indicator X, an evaluation indicator Y, an evaluation indicator Z, and the evaluation indicator W.

The range specification unit 132 executes predetermined parameter calculation processing on the received given range information and the model information regarding the plurality of evaluation indicators, and thereby, specifies a range of a parameter in case that the plurality of evaluation indicators are included in the range represented by the given range information (step S131). The predetermined parameter calculation processing is a procedure similar to a procedure described in each of the example embodiments described above.

The indicator calculation unit 133 executes predetermined indicator calculation processing on the specified range of the parameter and target model information representing model information regarding a target evaluation indicator, and thereby, calculates a characteristic value regarding the target evaluation indicator (step S132). The characteristic value is, for example, a value such as a maximum value, a minimum value, a local maximum value, or a local minimum value. The predetermined indicator calculation processing is processing similar to the method described above in each of the example embodiments.

Therefore, when an evaluation indicator is included within a range represented by given range information, the indicator calculation device calculates a characteristic value (e.g., maximum, minimum, local minimum, or local maximum) regarding a target evaluation indicator.

The range specification unit 132 can be achieved by use of a function similar to a function included in the range specification unit 102 in FIG. 1, the range specification unit 102 in FIG. 6, or the range specification unit 122 in FIG. 8. The indicator calculation unit 133 can be achieved by use of a function similar to a function included in the indicator calculation unit 103 in FIG. 1, the indicator calculation unit 103 in FIG. 6, or the indicator calculation unit 123 in FIG. 8. Therefore, the indicator calculation device 131 can be achieved by use of a function similar to a function included in the indicator calculation device 101 in FIG. 1, a function included in the indicator calculation device 111 in FIG. 6, or a function included in the indicator calculation device 121 in FIG. 8.

Next, an advantageous effect regarding the indicator calculation device 131 according to the fourth example embodiment of the present invention will be described.

The indicator calculation device 131 according to the fourth example embodiment can calculate a preferable evaluation indicator even when a relevance (dependency) among a plurality of evaluation indicators for the target system 161 is unclear. A reason for this is that the indicator calculation device 131 specifies a state of the target system 161 in case that a plurality of evaluation indicators are within a range represented by given range information, and calculates a characteristic value regarding a target evaluation indicator in the specified state.

### Hardware Configuration Example

A configuration example of hardware resources that achieve an indicator calculation device according to each example embodiment of the present invention using a computer processing device (information processing device, computer) will be described. However, the indicator calculation device may be achieved using physically or functionally at least two calculation processing devices. Further, the indicator calculation device may be achieved as a dedicated device.

FIG. 12 is a block diagram schematically illustrating a hardware configuration of a calculation processing device capable of achieving an indicator calculation device according to each of the example embodiments of the present invention. A calculation processing device 20 includes a central processing unit (CPU) 21, a memory 22, a disk (disc) 23, a non-transitory recording medium 24, and a communication interface (hereinafter, expressed as. “communication I/F”) 27. The calculation processing device 20 may connect an input device 25 and an output device 26. The calculation processing device 20 can execute transmission/reception of information to/from another calculation processing device and a communication device via the communication I/F 27.

The non-transitory recording medium 24 is, for example, a computer-readable Compact Disc, Digital Versatile Disc. The non-transitory recording medium 24 may be Universal Serial Bus (USB) memory, Solid State Drive or the like. The non-transitory recording medium 24 allows a related program to be holdable and portable without power supply. The non-transitory recording medium 24 is not limited to the above-described media. Further, a related program can be carried via a communication network by way of the communication I/F 27 instead of the non-transitory recording medium 24.

In other words, the CPU 21 copies, on the memory 22, a software program (a computer program: hereinafter, referred to simply as a “program”) stored in the disk 23 when executing the program and executes arithmetic processing. The CPU 21 reads data necessary for program execution from the memory 22. When display is needed, the CPU 21 displays an output result on the output device 26. When a program is input from the outside, the CPU 21 reads the program from the input device 25. The CPU 21 interprets and executes an indicator calculation program (FIG. 2, FIG. 7, FIG. 9, or FIG. 11) present on the memory 22 corresponding to a function (processing) indicated by each unit illustrated in FIG. 1, FIG. 6, FIG. 8, or FIG. 10 described above. The CPU 21 sequentially executes the processing described in each example embodiment of the present invention.

In other words, in such a case, it is conceivable that the present invention can also be made using the indicator calculation program. Further, it is conceivable that the present invention can also be made using a computer-readable, non-transitory recording medium storing the indicator calculation program.

The present invention has been described using the above-described example embodiments as example cases. However, the present invention is not limited to the above-described example embodiments. In other words, the present invention is applicable with various aspects that can be understood by those skilled in the art without departing from the scope of the present invention.

A part of or all of the above-described example embodiments may be described as the following supplementary notes. However, the present invention exemplarily described in the above-described example embodiments is not limited to the following.

### Supplementary Note 1

An indicator calculation device comprising:

a range specification means for executing a predetermined processing on a given range of a plurality of evaluation indicators for a target system and model information representing a relevance between the evaluation indicators and a parameter and, thereby, specifying ranges of the parameter in case that the plurality of the evaluation indicators are within the given range; and

an indicator calculation means for executing a predetermined indicator calculation processing on the specified ranges of the parameter and target model information representing the model information regarding a target evaluation indicator for the target system and, thereby, calculating a characteristic value representing a character of the target evaluation indicator.

### Supplementary Note 2

The indicator calculation device according to supplementary note 1, wherein

the range specification means calculates the ranges of the parameter in case that a certain evaluation indicator among the plurality of the evaluation indicators is within the given range, specifies a common range to the calculated ranges of the parameter, and, thereby, specifies the ranges of the parameter in case that the plurality of the evaluation indicators are within the given range.

### Supplementary Note 3

The indicator calculation device according to supplementary note 1 or supplementary note 2, wherein

the model information is represented by a Gaussian radial basis function,

the target system is a thermal power plant system, and

the parameter is a parameter of coal quality to be fuel of the thermal power plant system.

### Supplementary Note 4

The indicator calculation device according to any one of supplementary notes 1 to 3, further comprising:

a determination means, wherein

the range specifier means executes the predetermined parameter calculation processing on the calculated characteristic value and the target model information and, thereby, specifies the parameters in case that the target evaluation indicator is the calculated characteristic value,

the determination means determines whether or not a second target evaluation indicator different from the target evaluation is determined by using the parameters specified by the range specification means, and

the indicator calculation means calculates the characteristic value for the second target evaluation indicator when the second target evaluation indicator is not determined.

### Supplementary Note 5

The indicator calculation device according to supplementary note 4, further comprising:

a selection means for selecting an evaluation indicator that is not determined by the specified parameters from the plurality of the evaluation indicators when the determination means determines that the second target evaluation indicator is determined by the parameters specified by the range specification means, wherein

the indicator calculation means calculates the characteristic value for the evaluation indicator selected by the section means.

### Supplementary Note 6

The indicator calculation device according to supplementary note 4 or supplementary note 5, wherein

the indicator calculation means calculates values of the second target evaluation indicator based on the specified parameters when the determination means determines that the second target evaluation indicator is determined for the parameters specified by the range specification means.

### Supplementary Note 7

The indictor calculation device according to any one of supplementary notes 4 to 6, wherein

the indicator calculation means outputs information representing that the second target evaluation indicator is determined when the determination means determines that the second target evaluation indictor is determined for the parameters specified by the range specification means.

### Supplementary Note 8

The indicator calculation device according to any one of supplementary notes 1 to 7, further comprising:

a model information generation means for generating the model information representing a relevance between the parameters and the evaluation indicators based on indicator information associating the parameters with the evaluation indicators.

### Supplementary Note 9

The evaluation calculation device according to supplementary note 8, wherein

the model information generation means specifies the parameters in case that values of coefficients in the generated model information satisfy a predetermined condition and outputs information representing the specified parameters.

### Supplementary Note 10

The indicator calculation device according to supplementary note 8, wherein

the model information generation means outputs information representing the parameters for the coefficients in descending order of values of the coefficients in the generated model information.

### Supplementary Note 11

An indicator calculation method, by an information processing device, comprising:

executing a predetermined processing on a given range of a plurality of evaluation indicators for a target system and model information representing a relevance between the evaluation indicators and a parameter and, thereby, specifying ranges of the parameter in case that the plurality of the evaluation indicators are within the given range; and

executing a predetermined indicator calculation processing on the specified ranges of the parameter and target model information representing the model information regarding a target evaluation indicator for the target system and, thereby, calculating a characteristic value representing a character of the target evaluation indicator.

### Supplementary Note 12

A recording medium for storing an indicator calculation program causing a computer achieve:

a range specification function for executing a predetermined processing on a given range of a plurality of evaluation indicators for a target system and model information representing a relevance between the evaluation indicators and a parameter and, thereby, specifying ranges of the parameter in case that the plurality of the evaluation indicators are within the given range; and

an indicator calculation function for executing a predetermined indicator calculation processing on the specified ranges of the parameter and target model information representing the model information regarding a target evaluation indicator for the target system and, thereby, calculating a characteristic value representing a character of the target evaluation indicator.

### REFERENCE SIGNS LIST

101 indicator calculation device
102 range specification unit
103 indicator calculation unit
151 model information storage unit
152 evaluation indicator information storage unit
161 target system
111 indicator calculation device
114 model information generation unit
121 indicator calculation device
122 range specification unit
123 indicator calculation unit
124 determination unit
125 selection unit
162 display device
131 indicator calculation device
132 range specification unit
133 indicator calculation unit
20 calculation processing device
21 CPU
22 memory
23 disk (disc)
24 non-transitory recording medium
25 input device
26 output device
27 communication IF

What is claimed is:

1. An indicator calculation device comprising:
a memory storing instructions; and
a processor connected to the memory and configured to execute the instructions to:
execute a predetermined processing on a given range of a plurality of evaluation indicators for a target system and model information representing a relevance between the evaluation indicators and a parameter and, thereby, specify ranges of the parameter in case that the plurality of the evaluation indicators are within the given range; and
execute a predetermined indicator calculation processing on the specified ranges of the parameter and target model information representing the model information regarding a target evaluation indicator for the target system and, thereby, calculate a characteristic value representing a character of the target evaluation indicator.

2. The indicator calculation device according to claim 1, wherein
the processor is configured to execute the instructions to:
calculate the ranges of the parameter in case that a certain evaluation indicator among the plurality of the evaluation indicators is within the given range, specifies a common range to the calculated ranges of the parameter, and, thereby, specify the ranges of the parameter in case that the plurality of the evaluation indicators are within the given range.

3. The indicator calculation device according to claim 1, wherein
the model information is represented by a Gaussian radial basis function,
the target system is a thermal power plant system, and
the parameter is a parameter of coal quality to be fuel of the thermal power plant system.

4. The indicator calculation device according to claim 1, wherein
the processor is configured to execute the instructions to:
execute the predetermined parameter calculation processing on the calculated characteristic value and the target model information and, thereby, specify the parameters in case that the target evaluation indicator is the calculated characteristic value,
determine whether or not a second target evaluation indicator different from the target evaluation is determined by using the specified parameters, and
calculate the characteristic value for the second target evaluation indicator when the second target evaluation indicator is not determined.

5. The indicator calculation device according to claim 4, wherein
the processor is configured to execute the instructions to:
select an evaluation indicator that is not determined by the specified parameters from the plurality of the evaluation indicators when determining that the second target evaluation indicator is determined by the specified parameters, and
calculate the characteristic value for the selected evaluation indicator.

6. The indicator calculation device according to claim 4, wherein
the processor is configured to execute the instructions to:
calculate values of the second target evaluation indicator based on the specified parameters when determining that the second target evaluation indicator is determined for the specified parameters.

7. The indictor calculation device according to claim 4, wherein
the processor is configured to execute the instructions to:
output information representing that the second target evaluation indicator is determined when determining that the second target evaluation indictor is determined for the specified parameters.

8. The indicator calculation device according to claim 1, further comprising:
the processor is configured to execute the instructions to:
generate the model information representing a relevance between the parameters and the evaluation indicators based on indicator information associating the parameters with the evaluation indicators.

9. The evaluation calculation device according to claim 8, wherein
the processor is configured to execute the instructions to:
specify the parameters in case that values of coefficients in the generated model information satisfy a predetermined condition and output information representing the specified parameters.

10. The indicator calculation device according to claim 8, wherein
the processor is configured to execute the instructions to:
output information representing the parameters for the coefficients in descending order of values of the coefficients in the generated model information.

11. An indicator calculation method, by an information processing device, comprising:
executing a predetermined processing on a given range of a plurality of evaluation indicators for a target system and model information representing a relevance between the evaluation indicators and a parameter and, thereby, specifying ranges of the parameter in case that the plurality of the evaluation indicators are within the given range; and
executing a predetermined indicator calculation processing on the specified ranges of the parameter and target model information representing the model information regarding a target evaluation indicator for the target system and, thereby, calculating a characteristic value representing a character of the target evaluation indicator.

12. A non-transitory recording medium for storing an indicator calculation program causing a computer achieve:
a range specification function configured to execute a predetermined processing on a given range of a plurality of evaluation indicators for a target system and model information representing a relevance between the evaluation indicators and a parameter and, thereby, specify ranges of the parameter in case that the plurality of the evaluation indicators are within the given range; and
an indicator calculation function configured to execute a predetermined indicator calculation processing on the specified ranges of the parameter and target model information representing the model information regarding a target evaluation indicator for the target system and, thereby, calculate a characteristic value representing a character of the target evaluation indicator.
